(19) United States
(12) Patent Application Publication
(10) Pub. No.: US 2008/0030007 A1
(43) Pub. Date: Feb. 7, 2008

(54) Cockpit Component

(75) Inventor: Lars Schumann, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/589,806

(22) PCT Filed: Feb. 16, 2005
(86) PCT No.: PCT/EP05/01531

§ 371 Date: May 23, 2007

(30) Foreign Application Priority Data
Feb. 18, 2004 (DE) 10 2004 007 785.1

(51) Int. Cl. B60R 21/16

(52) U.S. Cl. 280/728.1; 280/730.2; 280/731

(57) ABSTRACT

A cockpit component for a motor vehicle includes a basic body and an inflatable airbag cushion, and has an airbag cover for protecting vehicle occupants against injuries during traffic accidents. On an end side of an interior structure, facing the vehicle occupant, the airbag cover bears directly against the basic body and engages around at least one edge of that end side.

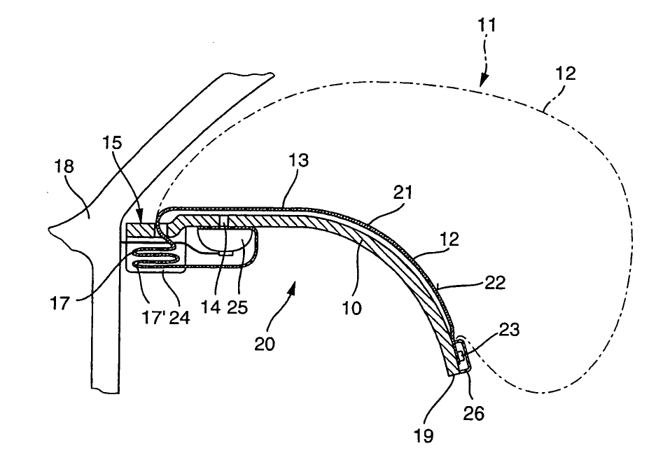

### BACKGROUND AND SUMMARY OF THE INVENTION

This invention relates to a cockpit component.

The cockpit component comprises a basic body and an inflatable airbag cushion with an airbag cover. As an interior protection device, airbags of this type belong to the standard equipment of modern motor vehicles. It is known that airbags, as inflatable cushions, are fitted in a folded-up state into various components adjacent to the interior of a vehicle, such as, for example, into the impact-absorbing element of a steering wheel, into a dashboard in front of the passenger, in an armrest, etc.

An airbag structure, in which the airbag cushion is embedded into the padding of the front wall, is previously known from German document DE 2063478. In this structure, the airbag cushion is fitted behind coverings of the components, which coverings can be torn open or can be opened up and which, if the need arises, form, at pre-defined desired breaking points, openings through which the cushion deploys. The desired breaking points are broken through by the expanding airbag, but this has disadvantageous effects on the inflation behavior of the airbag because energy is lost as a result. In addition, there is the risk that, when the covering is torn open or opened up, the cover of the inflatable cushion is damaged, as a result of which the protective function of the airbag is impaired or eliminated.

German document DE 199 34 249 shows an occupant protection device comprising an inflatable cushion, the cover of which, in its starting form, is embedded directly behind the end side of the interior of a vehicle and, in the inflated state, assumes a predetermined form. Although desired tearing lines or flaps on interior parts are to be avoided by this previously known structure, the freedom in terms of structure and design is restricted as a result.

Furthermore, European document EP 0 895 903 A1 discloses a paneling component for vehicles, in which an airbag faces the interior with a decorative layer. In the normal state, the latter bears flat against an essentially stiff and gastight support and engages around the latter at the edges. The material of the airbag or the decorative layer is expandable, so that it can be inflated after triggering.

U.S. Pat. No. 3,951,427 discloses an occupant protection device, in which the cover of the airbag is arranged on a side, which faces the interior, of an interior structure. It has an inflation reservoir in the form of folds in the airbag cover which is arranged between the visible side of the airbag and that side of the interior structure which faces the interior.

German document DE 101 23 207 C1, which relates to a device of the generally known type, discloses a cockpit component in which the cover of the airbag engages around the edges of an interior structure. On that side of the interior structure which faces the interior, an inflation reservoir is provided in the form of cover folds resting on the side.

The invention has as an object the object of improving the inflation behavior of the airbag while at the same time providing creative freedom in terms of structure and design.

The object is achieved according to the invention.

Advantageous refinements and advantages of the invention can be gathered from the description and the claims.

According to the invention, on the end side facing the vehicle occupant, the airbag cover bears directly against the basic body and engages around at least one of the edges of the latter. The airbag cover is therefore not fitted behind a covering of the interior components of the cockpit but rather is in direct contact with the basic body. An inflation reservoir and a gas generator are arranged behind the end side of the basic body. When used correctly, a charging of the air pressure in the inflation reservoir takes place by means of the gas being discharged from the gas generator. As a result, no desired breaking points which can be torn open and through which the airbag cover can deploy are provided. This avoids the disadvantageous effect of sharp edges which could damage the airbag cushion being produced at these desired breaking points. In addition, the structure according to the invention has the advantage that, when the airbag cover is inflated when the need arises, energy for piercing the desired breaking point in the covering of the previously known structures is not lost, but rather all of the energy is invested in the deployment of the airbag cushion. This has positive effects on the protective function of the airbag cushion because, as a result, a delay-free and unretarded tearing-open behavior is ensured in the use situation. Overall, the effectiveness and quality of the airbag cushion are therefore improved.

Provision can be made for the basic body together with the inflatable airbag cushion to form a separate module. This is fitted in one piece into the interior structure of the cockpit, which facilitates the installation as a whole considerably. In addition, the freedom in terms of structure and design are considerably improved as a result. This creative freedom is considerably restricted in the previously known structures due to the covering plates and desired breaking points provided.

The module can be fitted into an interior structure on the passenger's side, for example into a dashboard, and/or into a steering wheel on the driver's side, for example into an impact-absorbing element. Structures according to the invention are also possible in an armrest of the door, a door pillar lining, a door space lining, an armrest of the seat or a head restraint.

In an advantageous development of the structure according to the invention, the inflation reservoir has folds which, depending on their number, are intended to permit the airbag cushion to optimally expand into an inflated state and to prevent an overexpansion or bursting of the airbag cushion.

Provision can be made for the airbag cover to be at least partially composed of a fabric which is matched to the surface structure of the interior structure. This permits a harmonious configuration of the surface of the interior structure of the cockpit, which results in a uniform external appearance.

In the inflated state, the airbag cover, of course, has a substantially larger surface than in the inactive starting state, and so the fabric is expandable. Use is advantageously made here of materials composed of natural or synthetic polymeric plastics with elastic and, as far as possible, elastomeric behavior. It can also be provided with a coating, for example of foamed plastic, which is intended to reduce the momentum of the impact during the deployment of the airbag cushion.

The invention is explained in more detail below with reference to an exemplary embodiment described in the drawing. The drawing, the description and the claims contain numerous features in combination which a person skilled in the art will expediently also consider individually and will put them together to form meaningful further combinations.

### BRIEF DESCRIPTION OF THE DRAWING

The single FIGURE schematically shows a section through a cockpit component according to the invention.

### DETAILED DESCRIPTION OF THE INVENTION

According to the FIGURE, the cockpit component for a motor vehicle comprises a basic body 10, an inflatable airbag cushion 11 and an airbag cover 12 for protecting vehicle occupants against injuries during traffic accidents. In the inactive starting state, on an end side 13 facing the vehicle occupant, the airbag cover 12 bears directly against the basic body 10. In the inflated state, the airbag cushion 11 assumes the form shown by broken lines in the FIGURE.

In the inactive state, the airbag cover 12 engages around an edge 18 of the end side 13, which faces the vehicle occupant, of an interior structure 15 of the motor vehicle, leads at this edge 18 into the interior of the interior structure 15 and opens into an inflation reservoir 24.

At a second edge 19, the airbag cover 12 is connected fixedly to the basic body 10 by means of a fastening element 23, for example by adhesive bonding, clamping or welding. For protection or for visual covering, the fastening element 23 is fitted behind a covering 26.

If the need arises, the airbag cushion 11 is activated by a gas generator 25, which is situated behind the end side 13 of the basic body 10, charging the space between airbag cover 12 and interior structure 15 with air pressure via a channel 14, as a result of which the expandable fabric 21 expands and assumes the predetermined form of the airbag cushion 11. Folds 17, 17′, which are intended to permit optimum expansion of the airbag cushion 11, with regard to the protective function, and are intended to prevent an overexpansion are provided in the inflation reservoir 24.

The basic body 10 together with the inflatable airbag cushion 11 forms a separate module 20 which, in the FIGURE, is fitted in one piece into the interior structure 15 on the passenger's side, with the edge 18 of the basic body 10, as cockpit component, adjoining the interior structure 15 in a precisely fitting manner.

The airbag cover 12 is at least partially composed of a fabric 21 which is matched to the surface structure of the interior structure 15.

The fabric 21 of the airbag cover 12 is provided with a coating 22, for example with a foamed plastic. This serves to protect the vehicle occupants against injuries which may occur due to the momentum of the deployment of the airbag cushion 11.

1-9. (canceled)

10. A cockpit component for a motor vehicle, including a basic body and an inflatable airbag cushion, comprising:
an airbag cover for protecting vehicle occupants against injuries during traffic accidents, the airbag cover, on an end side of the basic body facing the vehicle occupant, bearing directly against the basic body and engaging around at least one edge of the end side, and
an inflation reservoir provided for the airbag cover,
wherein the inflation reservoir is arranged behind the end side of the basic body.

11. The cockpit component as claimed in claim 10, wherein the basic body, together with the inflatable airbag cushion, forms a separate module.

12. The cockpit component as claimed in claim 11, wherein the module is fitted into interior structure on a passenger's side.

13. The cockpit component as claimed in claim 11, wherein the module is fitted into a steering wheel on a driver's side.

14. The cockpit component as claimed in claim 10, wherein a gas generator is arranged behind the end side of the basic body.

15. The cockpit component as claimed in claim 10, wherein the inflation reservoir has folds to permit the airbag cushion to expand into an inflated state.

16. The cockpit component as claimed in claim 10, wherein the airbag cover is at least partially composed of a fabric which is matched to surface structure of an interior structure.

17. The cockpit component as claimed in claim 16, wherein the fabric of the airbag cover is expandable.

18. The cockpit component as claimed in claim 16, wherein the fabric of the airbag cover is provided with a coating.

19. The cockpit component as claimed in claim 11, wherein the airbag cover is at least partially composed of a fabric which is matched to surface structure of an interior structure.

20. The cockpit component as claimed in claim 19, wherein the fabric of the airbag cover is expandable.

21. The cockpit component as claimed in claim 19, wherein the fabric of the airbag cover is provided with a coating.

22. The cockpit component as claimed in claim 12, wherein the airbag cover is at least partially composed of a fabric which is matched to surface structure of an interior structure.

23. The cockpit component as claimed in claim 22, wherein the fabric of the airbag cover is expandable.

24. The cockpit component as claimed in claim 22, wherein the fabric of the airbag cover is provided with a coating.

25. The cockpit component as claimed in claim 13, wherein the airbag cover is at least partially composed of a fabric which is matched to surface structure of an interior structure.

26. The cockpit component as claimed in claim 25, wherein the fabric of the airbag cover is expandable.

27. The cockpit component as claimed in claim 25, wherein the fabric of the airbag cover is provided with a coating.

28. The cockpit component as claimed in claim 11, wherein a gas generator is arranged behind the end side of the basic body.

29. The cockpit component as claimed in claim 12, wherein a gas generator is arranged behind the end side of the basic body.
